(19) United States
(12) Patent Application Publication
(10) Pub. No.: US 2011/0122459 A1
(43) Pub. Date: May 26, 2011

(54) Scanning and Capturing digital Images Using Document Characteristics Detection

(75) Inventors: Lydia M. DO, Raleigh, NC (US); Pamela A. NESBITT, Tampa, FL (US); Lisa Seacat DELUCA, San Francisco, CA (US)

(73) Assignee: International Business Machines Corporation, Armonk, NY (US)

(21) Appl. No.: 12/624,763

(22) Filed: Nov. 24, 2009

(51) Int. Cl. H04N 1/04

(52) U.S. Cl. 358/474

(57) ABSTRACT

A mechanism for scanning and capturing digital images using document characteristics detection. Upon detecting a document placed on a scanning surface of a scanning device, the illustrative embodiments identify characteristics of the document. The illustrative embodiments detect that a characteristic of the document indicates the document comprises a defect. A portion of the document to be scanned is determined based on a location of the detected defect. The illustrative embodiments then scan the portion of the document.

### BACKGROUND

1. Field

The illustrative embodiments relate generally to a document scanning system and in particular to a system and method for scanning and capturing digital images using document characteristics detection.

2. Description of the Related Art

Scanners are an important part of a word processing and/or personal computer environment. A scanner is a device that optically scans printed or handwritten paper documents, objects, and photographs and creates digital images. One example of a scanner is a desktop or flatbed scanner that comprises a glass window on which a document is placed. A light positioned under the glass window is moved across the document to capture a digital image of the document and store the image in memory. With the digital image in memory, the image may be displayed, copied, transferred, printed, or altered as desired.

Scanning software, called a driver, is utilized to capture an image of a document. TWAIN is a common software language that scanner manufacturers use to communicate with scanners. The TWAIN driver acts as an interpreter between any application that supports the TWAIN standard and the scanner. The user configures the controls provided by the TWAIN driver to specify the scanning mode (e.g., color or black and white), the scanning resolution (e.g., 100 dpi or 200 dpi), the area on the flatbed glass window to be scanned, and other scanning characteristics, such as desired tonal quality and color balance of the scanned image. Once a document that has been placed on the glass window has been scanned, the TWAIN driver transfers the scanned image into memory.

After the images are stored in memory, a user may need to edit a scanned image because the image contains unwanted or irrelevant detail. A user may edit the scanned image using a graphics editing software product such as Adobe® Photoshop®. The graphics editing software enables a user to remove unwanted detail by cropping the image. Cropping refers to removing unnecessary or unwanted portions of the image, thereby improving the overall composition of the document.

### SUMMARY

The illustrative embodiments provide a mechanism for scanning and capturing digital images using document characteristics detection. Upon detecting a document placed on a scanning surface of a scanning device, the illustrative embodiments identify characteristics of the document. The illustrative embodiments detect that a characteristic of the document indicates the document comprises a defect. A portion of the document to be scanned is determined based on a location of the detected defect. The illustrative embodiments then scan the portion of the document.

### BRIEF DESCRIPTION OF THE SEVERAL VIEWS OF THE DRAWINGS

FIG. 1 is a block diagram of an exemplary document scanning system for capturing a digital image of an object in accordance with the illustrative embodiments;

FIG. 2 is a block diagram of a data processing system with which the illustrative embodiments may be implemented;

FIG. 3 is a block diagram of a scanning device with which the illustrative embodiments may be implemented;

FIG. 4 illustrates a scanning surface for capturing digital images based on document characteristics detection in accordance with the illustrative embodiments; and

FIG. 5 is a flowchart of a process for capturing a digital image of a document based on document characteristics detection in accordance with the illustrative embodiments.

### DETAILED DESCRIPTION

As will be appreciated by one skilled in the art, aspects of the disclosure may be embodied as a system, method or computer program product. Accordingly, aspects of the disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the disclosure may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the aspects of the disclosure may be written in any combination of one or more programming languages, including an object oriented programming language such as Java, Smalltalk, C++, Voice eXtensible Markup Language (VXML) or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The aspects of the disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The scanner of the illustrative embodiments allows for capturing a digital image of a document based on detecting specific defect characteristics of the document. A document characteristic is an attribute of the document that defines the current lighting exposure within the document or the faded or unfaded physical condition of the document. In one embodiment, the user may configure the software to selectively scan particular areas of a document if the areas are determined to meet a minimum quality standard. For instance, the upper right corner of a photograph may be overexposed or underexposed. An overexposed photograph is a photograph containing too much light in at least one area or the wrong camera settings, resulting in a loss of detail in bright areas and a whitish, washed-out, faded-looking image. An underexposed photograph is a photograph in which too little light reached the film, resulting in a loss of detail in the dark areas. The scanning software detects that the corner of the photograph is overexposed or underexposed and subsequently scans only those areas of the photo that are undamaged. Similarly, if the left edge of the photograph is faded due to sun exposure, the scanning software will not scan this damaged portion of the photo. The scanned image may comprise a white or black area representing the damaged area of the photo, or alternatively, the color(s) surrounding the damaged area may be detected by the scanning software and reproduced on the scanned image in place of the corresponding damaged portion.

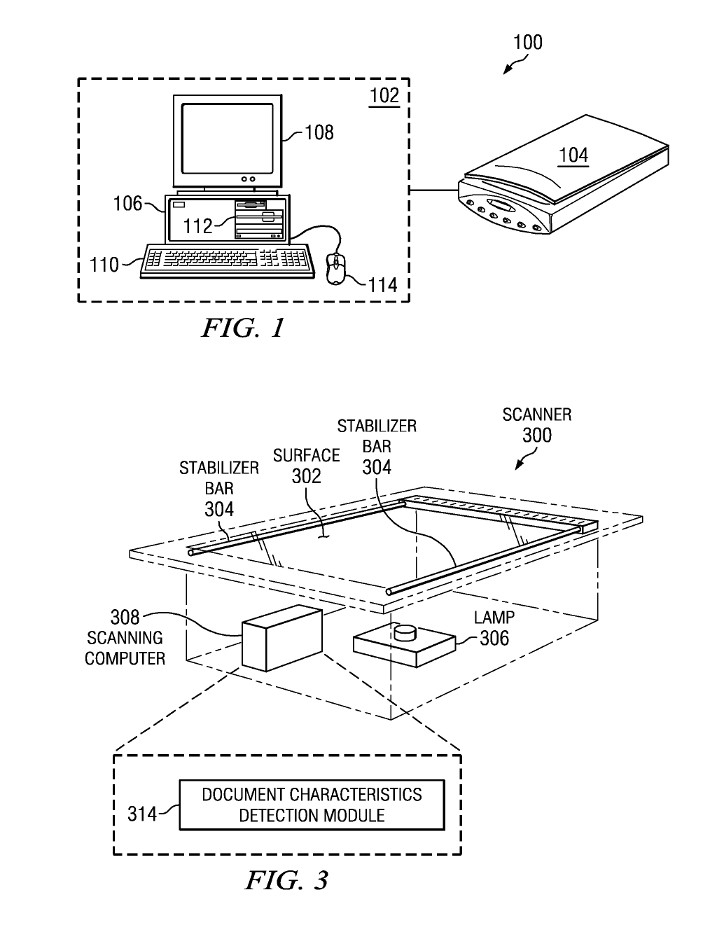

With reference now to the figures and in particular with reference to FIG. 1, a pictorial representation of an exemplary document scanning system for capturing a digital image of an object in accordance with the illustrative embodiments is shown. In this illustrative example, data processing system 100 comprises a computer 102 and a scanning device 104. Computer 102 includes system unit 106, video display terminal 108, keyboard 110, storage unit 112, which may include floppy drives and other types of permanent and removable storage media, and mouse 114. Additional input devices may be included with computer 102, such as, for example, a joystick, touchpad, touch screen, trackball, microphone, and the like. Computer 102 may be implemented using any suitable computer, such as an IBM® eServer® computer or IntelliStation® computer, which are products of IBM Corporation, located in Armonk, N.Y. Although the depicted representation shows a computer, other embodiments of the present invention may be implemented in other types of data processing systems, such as a network computer. Computer 102 may also include a graphical user interface (GUI) that may be implemented by means of systems software residing in computer readable media in operation within computer 102.

Scanning device 104 may be connected to computer 102 via wire links, wireless communication links, or fiber optic cables. In the depicted example, scanning device 104 is a flatbed scanner that comprises a glass window. When a document is placed on the glass window, a light positioned under the glass window is moved across the document to capture a digital image of the document and store the image in memory. The portions of the document that are actually captured by scanning device 104 in accordance with the illustrative embodiments are described in further detail in FIGS. 3-5.

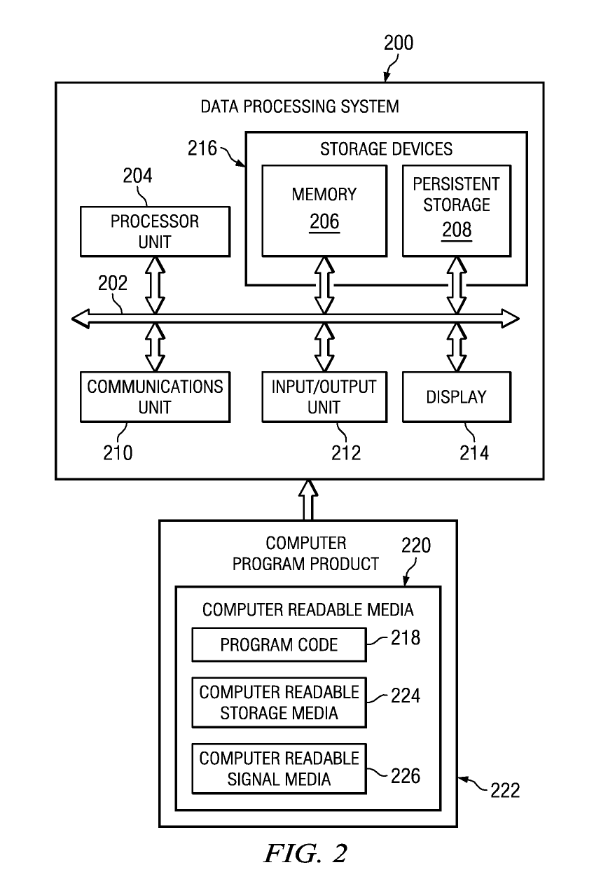

Turning now to FIG. 2, a block diagram of an exemplary data processing system with which the illustrative embodiments may be implemented. Data processing system 200 is an example of a computer, such as computer 102 shown in FIG. 1 or computer 308 in FIG. 3, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems, in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example, without limitation, data, program code in functional form, and/or other suitable information either on a temporary basis and/or a permanent basis. Memory 206, in these examples, may be, for example, a random access memory, or any other suitable volatile or non-volatile storage device. Persistent storage 208 may take various forms, depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 may be removable. For example, a removable hard drive may be used for persistent storage 208.

Communications unit 210, in these examples, provides for communication with other data processing systems or devices. In these examples, communications unit 210 is a network interface card. Communications unit 210 may provide communications through the use of either or both physical and wireless communications links.

Input/output unit 212 allows for the input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications, and/or programs may be located in storage devices 216, which are in communication with processor unit 204 through communications fabric 202. In these illustrative examples, the instructions are in a functional form on persistent storage 208. These instructions may be loaded into memory 206 for execution by processor unit 204. The processes of the different embodiments may be performed by processor unit 204 using computer implemented instructions, which may be located in a memory, such as memory 206.

These instructions are referred to as program code, computer usable program code, or computer readable program code that may be read and executed by a processor in processor unit 204. The program code, in the different embodiments, may be embodied on different physical or computer readable storage media, such as memory 206 or persistent storage 208.

Within memory 206 or persistent storage 208, computer program instructions for an object display application for displaying an image of an object placed on the surface of scanning device 104 in FIG. 1 are provided. The object display application may operate generally for displaying an image on display 214 of an object placed on the scanning device by: detecting an object placed on the scanning surface, identifying a region of the surface upon which the object is placed, scanning, using the scanner, the identified region of the surface to create an object image of the object, and rendering the object image within the identified region. The object placed on the scanning surface may be implemented as a pictorial document such as a photograph or other printed graphic image, a text document, a hand, a portable computing device, or any other object as will occur to those of skill in the art.

In addition, a set of computer program instructions for a scanner device driver for operating scanner 104 in FIG. 1 is also provided within persistent storage 208 and is loaded into memory 206. The scanner device driver comprises scanning software that exposes an application programming interface (‘API’) to the object display application that may be used to scan a region of the scanning surface to create an image of any objects placed in the region. The scanner device driver may be implemented in any number of ways and provide a variety of interfaces as will occur to those of skill in the art, including those according to the TWAIN specification promulgated by the TWAIN Working Group, the Image and Scanner Interface Specification (‘ISIS’) developed by Pixel Translations, the Scanner Access Now Easy (‘SANE’) specification, and so on.

Program code 218 is located in a functional form on computer readable media 220 that is selectively removable and may be loaded onto or transferred to data processing system 200 for execution by processor unit 204. Program code 218 and computer readable media 220 form computer program product 222. In one example, computer readable media 220 may be computer readable storage media 224 or computer readable signal media 226. Computer readable storage media 224 may include, for example, an optical or magnetic disc that is inserted or placed into a drive or other device that is part of persistent storage 208 for transfer onto a storage device, such as a hard drive, that is part of persistent storage 208. Computer readable storage media 224 also may take the form of a persistent storage, such as a hard drive, a thumb drive, or a flash memory that is connected to data processing system 200. In some instances, computer readable storage media 224 may not be removable from data processing system 200.

Alternatively, program code 218 may be transferred to data processing system 200 using computer readable signal media 226. Computer readable signal media 226 may be, for example, a propagated data signal containing program code 218. For example, computer readable signal media 226 may be an electro-magnetic signal, an optical signal, and/or any other suitable type of signal. These signals may be transmitted over communications links, such as wireless communications links, an optical fiber cable, a coaxial cable, a wire, and/or any other suitable type of communications link. In other words, the communications link and/or the connection may be physical or wireless in the illustrative examples.

In some illustrative embodiments, program code 218 may be downloaded over a network to persistent storage 208 from another device or data processing system through computer readable signal media 226 for use within data processing system 200. For instance, program code stored in a computer readable storage media in a server data processing system may be downloaded over a network from the server to data processing system 200. The data processing system providing program code 218 may be a server computer, a client computer, or some other device capable of storing and transmitting program code 218.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. The different embodiments may be implemented using any hardware device or system capable of executing program code. As one example, data processing system 200 may include organic components integrated with inorganic components and/or may be comprised entirely of organic components excluding a human being. For example, a storage device may be comprised of an organic semiconductor.

As another example, a storage device in data processing system 200 is any hardware apparatus that may store data. Memory 206, persistent storage 208, and computer readable media 220 are examples of storage devices in a tangible form. In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

FIG. 3 is a block diagram of a scanning device with which the illustrative embodiments may be implemented. Scanner 300 is a device that captures a digital image of an object. In this illustrative example, scanner 300 is implemented using a charged-coupled device (‘CCD’) array. The CCD array is a collection of tiny light-sensitive diodes, which convert photons into electrons. Each diode is called a photosite and is sensitive to light—the brighter the light that hits a single photosite, the greater the electrical charge that will accumulate at that site. The image of the object scanned reaches the CCD array through a series of mirrors, filters and lenses. The exact configuration of these components will vary from one embodiment to another. Scanner 300 includes one or more lamps 306 to illuminate the object. The lamps may be implemented using cold cathode fluorescent lamps (‘CCFL’), xenon lamps, standard fluorescent lamps, diodes, or any other implementation as will occur to those of skill in the art. The size and number of lamps may be configured in scanner 300 in any number of ways as will occur to those of skill in the art to provide varying levels of granularity regarding the portion of scanning surface 302 illuminated by the lamps. In some embodiments, only the lamps directly beneath the object being scanned will be turned on to prevent obscuring any remaining portions of the surface during the scanning process.

Scanner 300, which includes the mirrors, lens, filters, CCD array, lamps, and so on, moves across the underside of scanning surface 302 by a belt that is attached to a stepper motor. Scanner 300 is attached to stabilizer bars 304 to ensure that there is no wobble or deviation as the scanner passes beneath scanning surface 302. As scanner 300 passes beneath an object placed on scanning surface 302, the image of the object is reflected through a series of mirrors onto a lens. The lens splits the image into three smaller versions of the original. Each smaller version passes through a color filter, which is either red, green, or blue, onto a discrete section of the CCD array. Scanner 300 then combines the data from the three parts of the CCD array into a single full-color image.

Although scanner 300 is described above using CCD technology, other scanning technologies may also be useful in embodiments of the present invention. For example, a scanner in some embodiments may be implemented using contact image sensor (‘CIS’) technology. CIS technology replaces the CCD array, mirrors, filters, lamp and lens with rows of red, green and blue light emitting diodes (‘LEDs’). The image sensor mechanism, consisting of hundreds or thousands of individual sensors spanning the width of scanning surface 302, is placed very close to scanning surface 302 on which the object rests. When the object is scanned, the LEDs combine to provide white light. The illuminated image of the object is then captured by the row of sensors. Still further, readers will appreciate that other scanning technologies may be used. The CCD scanner and the CIS scanner described above are for explanation only and not for limitation.

Scanning computer 308 comprises document characteristics detection module 314. In one embodiment, scanning computer 308 is an example of data processing system 200 in FIG. 2. Document characteristics detection module 314 in scanning computer 308 comprises software for detecting specific defect characteristics of a document to be scanned. Document characteristics detection module 314 may be configured by a user to eliminate scanning an area of a document if the area comprises a defect and fails to meet a minimum quality standard. Defects may include physical damage to a document due to sun exposure, or lighting defects that cause loss of information in the document, such as blown-out highlights or crushed black levels in a photograph. Areas of a photo where information is lost due to extreme brightness are described as “blown-out highlights”. Areas of a photo where information is lost due to extreme darkness are described as “crushed blacks”. For example, document characteristics detection module 314 may detect sun exposure or lighting defects in a corner of the document and determine this portion of the document is damaged and unrecoverable. Document characteristics detection module 314 may subsequently identify only those areas of the photo that are undamaged, and may compensate for the damaged areas by detecting a color(s) surrounding the damaged area and instructing scanner 300 to substitute the damaged areas with the detected color(s) in the scanned image in a final output of a digital image of the document.

It should be appreciated that FIGS. 1-3 are only exemplary and are not intended to assert or imply any limitation with regard to the environments in which different embodiments may be implemented. Many modifications to the depicted environments may be made.

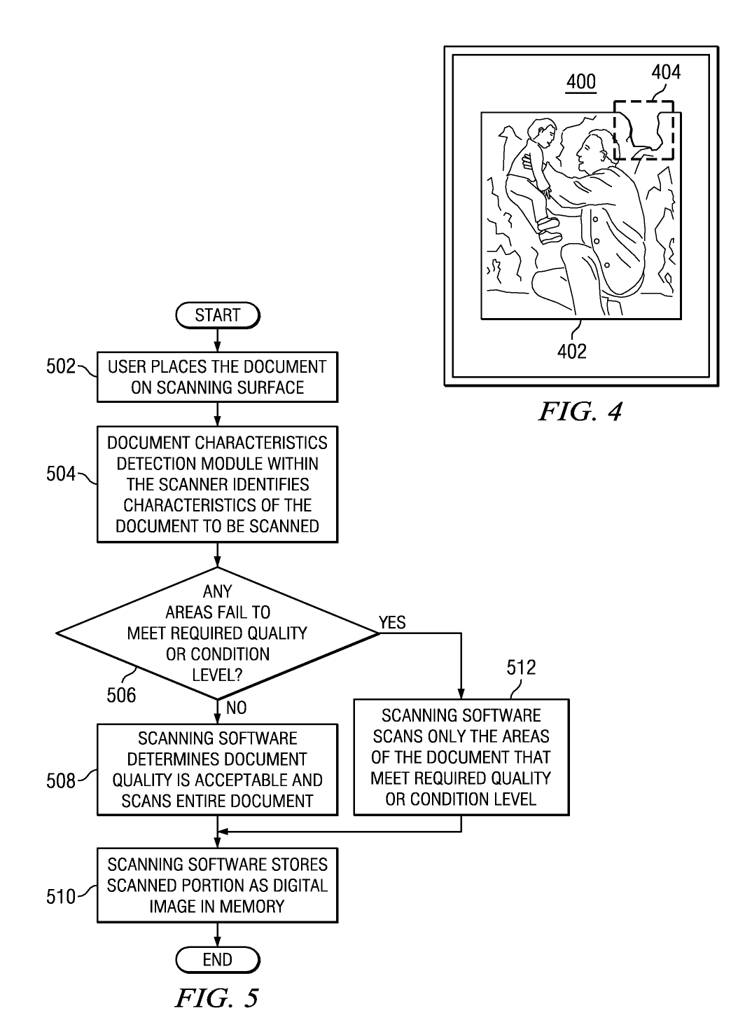

FIG. 4 illustrates a scanning surface for capturing digital images based on document characteristics detection in accordance with the illustrative embodiments. The scanning surface is an example of scanning surface 302 in scanner 300 in FIG. 3. The scanner uses document characteristics detection module 314 in FIG. 3 to detect characteristics on a document placed on scanning surface 302. A document characteristic is an attribute of the document that defines the current lighting exposure within the document or the faded or unfaded physical condition of the document. The scanner captures only the area(s) of the document that is determined to meet a certain quality or condition level.

In FIG. 4, document 402 to be scanned is shown placed on scanning surface 400 (i.e., viewed from the underside of scanning surface 400). Scanner 300 in FIG. 3 comprises a document characteristics detection module that identifies specific characteristics of the document to be scanned using any known document characteristics detection technology. The document characteristics detection module identifies characteristics of interest of document 402. The document characteristics detection module informs the scanning software loaded into memory in data processing system 200 in FIG. 2 (or within the document characteristics detection module itself) that the document to be scanned comprises specific characteristics of interest. The scanning software may be configured by the user to define document characteristics that fail to meet a specific quality or condition level, such as under or overexposed areas in a photograph, faded areas in a document or photograph, or damaged areas in a document or photograph. In this illustrative example, document 402 is a photograph that has a damaged area 404. Based on the detection of damaged area 404, the scanning software subsequently scans only the areas of the photograph that are undamaged. Thus, the scanned image of document 402 will not include damaged area 404.

FIG. 5 is a flowchart of a process for capturing a digital image of a document based on document characteristics detection in accordance with the illustrative embodiments. The process begins with a user placing the document to be scanned onto the scanning surface of the scanner, such as scanner 300 in FIG. 3 (step 502). A document characteristics detection module within the scanner identifies characteristics of the document to be scanned (step 504). The document characteristics detection module may detect the document characteristics based on the condition or quality of the document, such as over or underexposed or sun damaged areas of the document. The scanning software makes a determination whether any areas of the document comprise a characteristic that fails to meet a required quality or condition level (step 506). If all areas of the document comprise characteristics that meet required quality or condition levels (‘no’ output of step 506), the process determines that the document quality is acceptable for scanning and captures a digital image of the entire document in a traditional manner (step 508). The scanned portion is then stored as a digital image in memory (step 510), with the process terminating thereafter.

Turning back to step 506, if an area of the document comprises a characteristic that fails to meet a required quality or condition level (‘yes’ output of step 506), the process captures a digital image of only the areas of the document that meet the required quality or condition levels, while omitting the areas that have been identified as damaged or of low quality (step 512). The scanned portion is then stored as a digital image in memory (step 510), with the process terminating thereafter.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for scanning a document, the computer implemented method comprising:
detecting a document placed on a scanning surface of a scanning device;
identifying characteristics of the document;
detecting that a characteristic of the document indicates the document comprises a defect comprising at least one of an overexposed, underexposed, or sun damaged area of the document;
determining a portion of the document to be scanned based on a location of the detected defect; and
scanning, by the scanning device, the portion of the document.

2. The computer implemented method of claim 1, wherein detecting that a characteristic of the document indicates the document comprises a defect further comprises:
determining if the characteristic exceeds a minimum quality level for scanning the document; and
responsive to a determination that the characteristic exceeds a minimum quality level for scanning the document, identifying an area of the document comprising the characteristic as a damaged area of the document.

3. The computer implemented method of claim 1, wherein detecting that a characteristic of the document indicates the document comprises a defect further comprises:
receiving input from a user indicating the document comprises a defect.

4. The computer implemented method of claim 2, further comprising:
identifying an area of the document not comprising the characteristic as an undamaged area of the document; and
scanning the portion of the document identified as the undamaged area of the document.

5. The computer implemented method of claim 1, wherein the defect comprises unrecoverable information within the document.

6. The computer implemented method of claim 1, wherein the defect comprises blown-out highlights within the document.

7. The computer implemented method of claim 1, wherein the defect comprises crushed black levels within the document.

8. A computer program product for scanning a document, the computer program product comprising:
a computer usable storage medium having computer usable program code stored thereon, the computer usable program code comprising:
computer usable program code for detecting a document placed on a scanning surface of a scanning device;
computer usable program code for identifying characteristics of the document;
computer usable program code for detecting that a characteristic of the document indicates the document comprises a defect;
computer usable program code for determining a portion of the document to be scanned based on a location of the detected defect; and
computer usable program code for scanning the portion of the document.

9. The computer program product of claim 8, wherein the computer usable program code for detecting that a characteristic of the document indicates the document comprises a defect further comprises:
computer usable program code for determining if the characteristic exceeds a minimum quality level for scanning the document; and
computer usable program code for identifying, in response to a determination that the characteristic exceeds a minimum quality level for scanning the document, an area of the document comprising the characteristic as a damaged area of the document.

10. The computer program product of claim 8, wherein the computer usable program code for detecting that a characteristic of the document indicates the document comprises a defect further comprises:
computer usable program code for receiving input from a user indicating the document comprises a defect.

11. The computer program product of claim 9, further comprising:
computer usable program code for identifying an area of the document not comprising the characteristic as an undamaged area of the document; and
computer usable program code for scanning the portion of the document identified as the undamaged area of the document.

12. The computer program product of claim 8, wherein the defect comprises unrecoverable information within the document.

13. The computer program product of claim 8, wherein the defect comprises blown-out highlights within the document.

14. The computer program product of claim 8, wherein the defect comprises crushed black levels within the document.

15. The computer program product of claim 8, wherein the computer usable program code is stored in a computer readable storage medium in a data processing system, and wherein the computer usable program code is downloaded over a network from a remote data processing system.

16. The computer program product of claim 8, wherein the computer usable program code is stored in a computer readable storage medium in a server data processing system, and wherein the computer usable program code is downloaded over a network from a remote data processing system for use in a computer readable storage medium with the remote system.

17. A data processing system for scanning a document, the data processing system comprising:
a bus;
a storage device connected to the bus, wherein the storage device contains computer usable code; and
a processing unit connected to the bus, wherein the processing unit executes the computer usable code to detect a document placed on a scanning surface of a scanning device; identify characteristics of the document; detect that a characteristic of the document indicates the document comprises a defect; determine a portion of the document to be scanned based on a location of the detected defect; and scan the portion of the document.

18. The data processing system of claim 17, wherein the computer usable code to detect that a characteristic of the document indicates the document comprises a defect further comprises computer usable code to determine if the characteristic exceeds a minimum quality level for scanning the document; and, responsive to a determination that the characteristic exceeds a minimum quality level for scanning the document, identify an area of the document comprising the characteristic as a damaged area of the document.

19. The data processing system of claim 18, wherein the processing unit further executes the computer usable code to identify an area of the document not comprising the characteristic as an undamaged area of the document; and scan the portion of the document identified as the undamaged area of the document.

20. The data processing system of claim 17, wherein the defect comprises at least one of unrecoverable information within the document, blown-out highlights within the document, or crushed black levels within the document.
